(19) United States
(12) Patent Application Publication
(10) Pub. No.: US 2025/0047154 A1
(43) Pub. Date: Feb. 6, 2025

(54) ROTOR FOR AN ELECTRICAL MACHINE HAVING A TUBULAR COOLING CHANNEL

(71) Applicant: Valeo eAutomotive Germany GmbH, Erlangen (DE)

(72) Inventors: Nico WOLF, Bad Neustadt (DE); Alexander SCHLERETH, Bad Neustadt (DE); Regina NOACK, Bad Neustadt (DE); Carsten SIEPKER, Bad Neustadt (DE); Christoph WIECZOREK, Bad Neustadt (DE)

(73) Assignee: Valeo eAutomotive Germany GmbH, Erlangen (DE)

(21) Appl. No.: 18/720,183

(22) PCT Filed: Dec. 13, 2022
(86) PCT No.: PCT/EP2022/085683

§ 371 Date: Jun. 14, 2024

(30) Foreign Application Priority Data
Dec. 17, 2021 (DE) 10 2021 133 566.3

(51) Int. Cl. H02K 3/24; H02K 1/24; H02K 1/28; H02K 15/02

(52) U.S. Cl. CPC H02K 3/24; H02K 1/24; H02K 1/28; H02K 15/022

(57) ABSTRACT

Rotor for electric machine includes a rotor shaft, and a laminated core arranged on the rotor shaft and formed from stacked electrical laminations with radially outwardly protruding laminated core projections. A first end plate arranged on a first axial side of the laminated core with radially outwardly protruding end plate projections. A second end plate arranged on an opposite second axial side of the laminated core with radially outwardly protruding end plate projections. A plurality of rotor windings are respectively wound around an end plate projection of the first end plate, and an axially opposite end plate projection of the second end plate and a laminated core projection extends axially between the two end plate projections. A pot-shaped first end cap axially covers the first end plate, a pot-shaped second end cap axially covers the second end plate. A tubular cooling channel runs axially between two adjacent rotor windings.

The invention relates to a rotor for an electric machine, an electric machine with a rotor, a vehicle with an electric machine and a method for producing a rotor.

The rotor has a rotor shaft and a laminated core, arranged on the rotor shaft and formed from stacked electrical laminations. The rotor, together with a stator, belongs to an electric machine.

Electric machines of this type are increasingly used in electrically driven vehicles and hybrid vehicles, predominantly as electric motors for driving a wheel or an axle of such a vehicle.

Such an electric motor is usually mechanically coupled to a transmission for speed adaptation. In addition, the electric motor is usually electrically coupled to an inverter, which generates an AC voltage, for example a multiphase AC voltage, for the operation of the electric motor from a DC voltage supplied by a battery.

It is also possible to operate an electric machine with such a rotor as a generator for recuperating kinetic energy of a vehicle. For this purpose, the kinetic energy is first converted into electrical energy and then into chemical energy of a vehicle battery.

In a certain type of electrically excited synchronous motors (EESM), the rotor has rotor windings which are fed with direct current in order to generate a magnetic excitation field. If a rotating field is generated with the stator windings of an associated stator, this brings about an action of force on the rotor such that the latter rotates synchronously with the stator rotating field.

However, the rotor windings are greatly heated in the process, and therefore cooling is required. The cooling may for example take place by spraying oil onto the axial sides of the rotor. However, this type of cooling acts only superficially and therefore has little effect.

The invention is therefore based on the object of specifying a rotor for an electric machine which can be better cooled during operation.

To achieve this object, a rotor with the features of claim 1 is provided.

The rotor according to the invention comprises a laminated core, arranged on the rotor shaft and formed from stacked electrical laminations, with radially outwardly protruding laminated core projections, a first end plate, arranged on a first axial side of the laminated core, with radially outwardly protruding end plate projections, a second end plate, arranged on an opposite second axial side of the laminated core, with radially outwardly protruding end plate projections, a plurality of rotor windings, which are respectively wound around an end plate projection of the first end plate, an axially opposite end plate projection of the second end plate and a laminated core projection extending axially between the two end plate projections, a pot-shaped first end cap, which axially covers the first end plate, a pot-shaped second end cap, which axially covers the second end plate, and a tubular cooling channel for a coolant, running axially between two adjacent rotor windings from the first end cap to the second end cap.

The invention is based on the recognition that improved cooling can be achieved by feeding the coolant to the rotor windings via an axially running (axial) tubular cooling channel. The coolant flows along the rotor windings in the axial direction and dissipates the heat generated during operation of the rotor. In comparison with a conventional rotor, in which only oil is sprayed onto the axial sides, the rotor according to the invention can be cooled significantly better and more homogeneously. Another advantage of the cooling channel is the increase in the stability of the rotor, because the cooling channel causes a mechanical reinforcement. This allows troublefree operation of the electric machine, especially at high speeds.

The electric machine may be for example an electrically excited synchronous motor (EESM). The end plate projections of an end plate, which are also referred to as “plate extensions”, may be arranged along the circumference of the end plate. They serve, inter alia, for keeping the rotor windings in a certain position. The laminated core projections of the laminated core are also referred to as “teeth”.

In the rotor according to the invention, it may be provided that a first axial end of the cooling channel is arranged in an opening of the first end cap and/or an opposite second axial end of the cooling channel is arranged in an opening of the second end cap. This allows coolant to enter the cooling channel from axially outside the end caps. For this purpose, the openings are in particular through openings or holes in the end caps.

In the rotor according to the invention, it is preferred that the cooling channel is pressed into the end caps. Additional fastening of the cooling channel is then not necessary. The pressing-in has the effect that production of the rotor is simplified and the cooling channel is stably fixed in the rotor.

Preferably, the first axial end of the cooling channel has an inlet for coolant and the second axial end of the cooling channel has an outlet for coolant. This allows coolant to be fed to the cooling channel at the first end and to be drained from the cooling channel at the second end. Accordingly, the coolant flows through the entire axial length of the cooling channel, thereby achieving the desired homogeneous cooling. The flow direction can be chosen as desired, i.e. inlet and outlet may be reversed. The inlet and the outlet may be arranged axially or radially on the cooling channel.

According to a development of the invention, it may be provided that the cooling channel is embedded in a potting compound. For this purpose, the interspace between the two adjacent rotor windings, in which the cooling channel runs, may be potted with the potting compound. In particular, the rotor windings may also be potted with the potting compound such that movements or displacements of the rotor windings are prevented even at high speeds. The potting compound also improves heat dissipation from the rotor windings and further increases the stability of the rotor.

In the rotor according to the invention, it is preferred that it has a plurality of pole separators, which are each arranged between two adjacent laminated core projections of the laminated core. Such a pole separator may extend in the axial direction between the two opposite axial sides of the laminated core. The pole separators increase the stability of the rotor and simplify the potting of the interspaces between adjacent rotor windings with potting compound.

The cooling channel of the rotor according to the invention may be produced from, inter alia, a steel alloy, an aluminum alloy or a plastics material.

Instead of just one axial tubular cooling channel, which runs between two adjacent rotor windings from the first end cap to the second end cap, the rotor according to the invention may have a plurality of such cooling channels. It is particularly preferred that the number of cooling channels corresponds to the number of poles of the rotor. However, other versions in which the number of cooling channels is smaller or greater than the number of poles of the rotor are also possible. In particular, it is possible to provide such a cooling channel only in every second interspace between two adjacent rotor windings.

In addition, the invention relates to an electric machine with a rotor of the type described and a stator which surrounds the rotor. The rotor is rotatable with respect to the stator. The stator may have a further laminated core (stator core) which is formed from stacked electrical laminations. In addition, the stator may have windings of electrical conductors, for example in the form of coil windings or flat wire windings.

Preferably, the electric machine may additionally have a nozzle, which is directed at an inlet of the cooling channel. The nozzle may be fixedly connected to the stator, for example by the nozzle being fastened to a housing of the electric machine. The nozzle can be used to spray coolant into the cooling channel, which then flows through the cooling channel.

Furthermore, the invention relates to a vehicle with such an electric machine which is intended for driving the vehicle. The machine can in particular drive a wheel or an axle of the vehicle.

The invention also relates to a method for producing a rotor of the type described. The method according to the invention comprises the following steps: arranging the laminated core on the rotor shaft, arranging the first end plate on the first axial side of the laminated core, arranging the second end plate on the second axial side of the laminated core, winding the rotor windings respectively around an end plate projection of the first end plate, an axially opposite end plate projection of the second end plate and a laminated core projection of the laminated core extending axially between the two end plate projections, arranging pole separators respectively between two adjacent laminated core projections of the laminated core, axially covering the first end plate with the first end cap, axially covering the second end plate with the second end cap, arranging the cooling channel between two adjacent rotor windings such that the cooling channel runs axially from the first end cap to the second end cap, and potting the rotor windings with a potting compound such that the cooling channel is embedded in the potting compound.

For potting, the rotor may be positioned such that its axis of rotation runs vertically, and the potting compound may be introduced through a filling opening in an end cap, the end cap preferably also having a venting opening.

The invention will be explained below on the basis of an exemplary embodiment with reference to the figures. The figures are schematic representations and show:

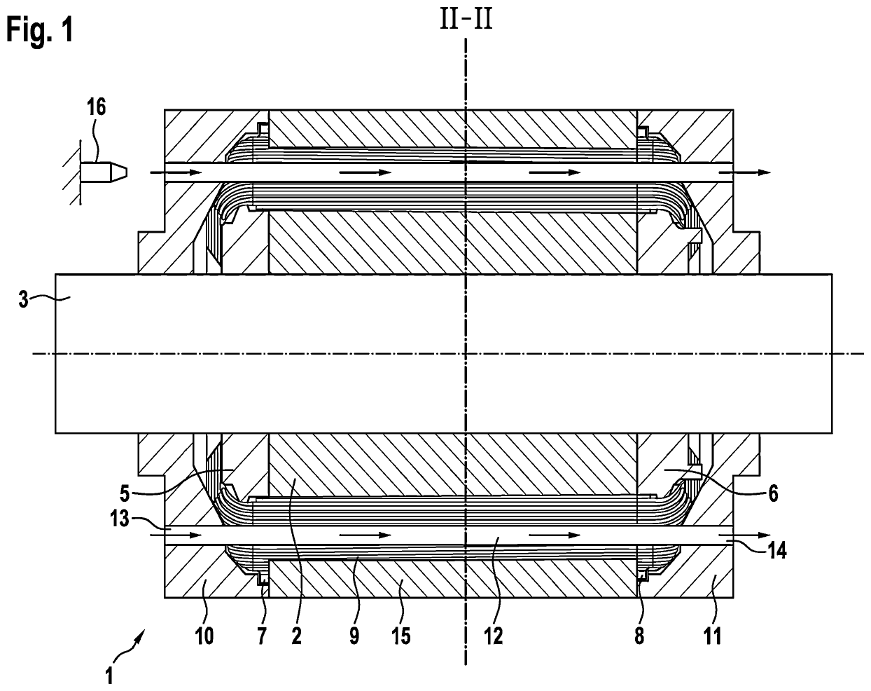

FIG. 1 a sectioned side view of a rotor according to the invention,

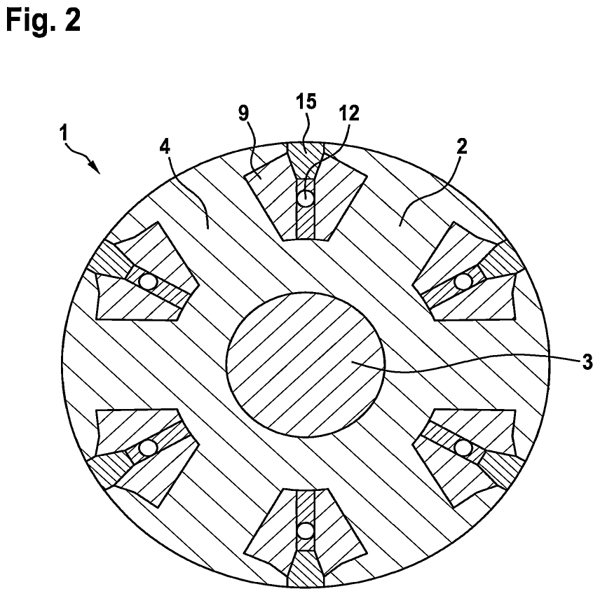

FIG. 2 a section along the line II-II of FIG. 1, and

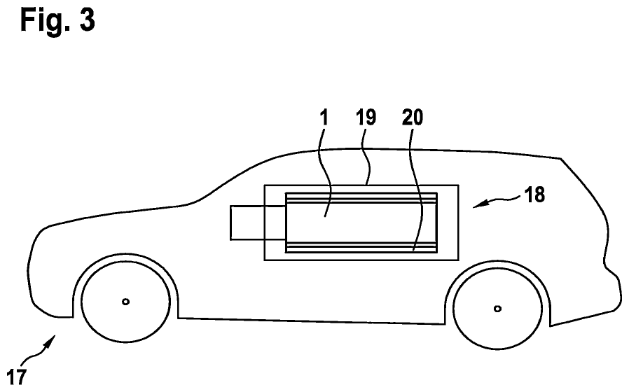

FIG. 3 a vehicle according to the invention with an electric machine.

The rotor 1 shown in FIG. 1 in a sectioned side view is intended for an electric machine, which is used as an electric motor for driving a vehicle. The rotor 1 comprises a cylindrical laminated core 2 which is formed from stacked electrical laminations and surrounds a rotor shaft 3 with a form fit and/or force fit. The electrical laminations can be identically formed punched parts. The laminated core 2 has a plurality of radially outwardly protruding laminated core projections 4 (see FIG. 2), which are also referred to as “teeth”. End sections of the laminated core projections 4 are widened in the circumferential direction.

A first end plate 5 is located on a first axial side of the laminated core 2. A second end plate 6 is located on the opposite, second axial side of the laminated core 2. The end plates 5, 6 each have radial end plate projections 7, 8 (also known as “plate extensions”), around which a plurality rotor windings 9 are wound. The rotor windings 9 consist of enameled copper wire. Both end plates 5, 6 each have an aluminum core, which is overmolded with plastic. Alternatively, the end plates could also consist entirely of plastic.

A pot-shaped first end cap 10 covers the first end plate 5. A pot-shaped second end cap 11 is located at the opposite axial end of the rotor 1 and covers the second end plate 6.

An axially running tubular cooling channel 12 for a coolant runs from the first end cap 10 to the second end cap 11. The tubular cooling channel 12 is pressed into the end caps 10, 11 and as a result is fixed with a form fit and a force fit. In the sectioned view of FIG. 2 it can be seen that a total of six such tubular cooling channels 12 are present. The number of cooling channels 12 consequently corresponds to the number of poles (“number of poles”) of the rotor 1.

Each cooling channel 12 is arranged in a clearance between two adjacent rotor windings 9. A first axial end 13 of the cooling channel 12 passes through an opening of the first end cap 10. An opposite second axial end 14 of the cooling channel 12 is arranged in an opening of the second end cap 11. An interspace between adjacent laminated core projections 4 or their widened ends is respectively covered by a pole separator 15, which is arranged radially outside the cooling channels 12.

The area surrounding a cooling channel 12, which is delimited radially inside by the laminated core 2, in the circumferential direction by two adjacent rotor windings 9 and radially outside by a pole separator 15, is potted with a potting compound. This causes the rotor windings 9 and the cooling channel 12 to maintain their position even at high speeds and heat emitted by the rotor windings 9 to be transported particularly well to the cooling channel 12.

The arrows in FIG. 1 indicate the flow direction of the coolant in the rotor 1 by way of example. The coolant may be, inter alia, a liquid, a gas, or an oil. All of the tubular cooling channels 12 run straight and in the axial direction. Since the cooling channels 12 pass along the rotor windings 9, heat is transferred from the rotor windings 9 to the coolant flowing in the cooling channels 12 and is dissipated with the coolant. As a result, the rotor windings 9 are cooled along their entire axial length.

Schematically shown in FIG. 1 is a nozzle 16, which is fixedly connected to the stator (not shown) of the electric machine, for example by the nozzle 16 being fastened to the housing of the electric machine. The nozzle 16 is directed at an axial inlet 13 of the cooling channel 12. During the operation of the electric motor, a coolant is sprayed by the nozzle 16 into the inlet 13. The coolant flows in the axial direction through the cooling channel 12 and leaves it through an axial outlet 14 at the opposite end of the cooling channel 12, after which it is collected in a coolant sump (not shown). The nozzle 16, the cooling channel 12 and the coolant sump belong to a cooling circuit through which the coolant is pumped by a coolant pump.

In the method for producing the rotor 1, the laminated core 2 is arranged on the rotor shaft 3, then the first end plate 5 is arranged on the first axial side of the laminated core 2 and the second end plate 6 is arranged on the second axial side of the laminated core 2. The rotor windings 9 are each produced by winding enameled copper wire around an end plate projection 7 of the first end plate 5, an axially opposite end plate projection 8 of the second end plate 6 and a laminated core projection 4 of the laminated core 2 extending axially between the two end plate projections 7, 8.

The pole separators 13 are then each positioned between two adjacent laminated core projections 4 of the laminated core 2. The first end plate 5 is axially covered by the first end cap 10 and the second end plate 6 is axially covered by the second end cap 11. The tubular cooling channel 12 is arranged between two adjacent rotor windings 9 such that the cooling channel 12 extends axially from the first end cap 10 to the second end cap 11. For this purpose, the cooling channel 12 can be pressed into the end caps 10, 11. Instead of just one cooling channel 12, a plurality of such cooling channels 12 may be arranged in the same way between two (other) adjacent rotor windings 9.

In a further method step, the rotor windings 9 are potted with a potting compound such that the cooling channels 12 are embedded in the potting compound. For this purpose, the potting compound is introduced in particular into the interspaces between adjacent rotor windings 9. This creates a form fit between the potting compound and the rotor windings 9.

For potting, the rotor 1 may be expediently brought into a vertical position with respect to its axial direction. Furthermore, the potting compound may be filled into or introduced into the rotor interior through a filling opening (not shown), which is formed in one of the end caps. The end cap preferably also has a venting opening, through which air inside the rotor can flow out.

FIG. 3 shows a vehicle 17 with an electric machine 18, which serves for driving the vehicle 17. The electric machine 18 has a housing 19, in which the rotor 1 according to the invention and a stator 20 which surrounds the rotor 1 are accommodated.

### LIST OF REFERENCE SIGNS

1 Rotor
2 Laminated core
3 Rotor shaft
4 Laminated core projection
5 First end plate
6 Second end plate
7 End plate projection
8 End plate projection
9 Rotor winding
10 First end cap
11 Second end cap
12 Cooling channel
13 Inlet
14 Outlet
15 Pole separator
16 Nozzle
17 Vehicle
18 Electric machine
19 Housing
20 Stator

1. A rotor for an electric machine, comprising:
a rotor shaft,
a laminated core, arranged on the rotor shaft and formed from stacked electrical laminations, with radially outwardly protruding laminated core projections,
a first end plate, arranged on a first axial side of the laminated core, with radially outwardly protruding end plate projections,
a second end plate, arranged on an opposite second axial side of the laminated core, with radially outwardly protruding end plate projections,
a plurality of rotor windings, which are respectively wound around an end plate projection of the first end plate, an axially opposite end plate projection of the second end plate and a laminated core projection extending axially between the two end plate projections,
a pot-shaped first end cap, which axially covers the first end plate,
a pot-shaped second end cap, which axially covers the second end plate, and
a tubular cooling channel for a coolant, running axially between two adjacent rotor windings from the first end cap to the second end cap.

2. The rotor as claimed in claim 1, wherein a first axial end of the cooling channel is arranged in an opening of the first end cap and an opposite second axial end of the cooling channel is arranged in an opening of the second end cap.

3. The rotor as claimed in claim 1, wherein the cooling channel is pressed into the end caps.

4. The rotor as claimed in claim 2, wherein the first axial end of the cooling channel has an inlet for coolant and the second axial end of the cooling channel has an outlet for coolant.

5. The rotor as claimed in claim 1, wherein the cooling channel is embedded in a potting compound.

6. The rotor as claimed in claim 1, with a plurality of pole separators, which are each arranged between two adjacent laminated core projections of the laminated core.

7. The rotor as claimed in claim 1, wherein the cooling channel is produced from a steel alloy, an aluminum alloy or a plastics material.

8. The rotor as claimed in claim 1, with a plurality of cooling channels corresponding to the cooling channel, the number of which corresponds to the number of poles of the rotor or deviates from the number of poles.

9. An electric machine, with a rotor as claimed in claim 1 and a stator surrounding the rotor.

10. The electric machine as claimed in claim 9, with a nozzle, which is fixedly connected to the stator and is directed at an inlet of the cooling channel.

11. A vehicle with an electric machine as claimed in claim 9, which is intended for driving the vehicle.

12. A method for producing a rotor as claimed in claim 1, with the following steps:
arranging the laminated core on the rotor shaft,
arranging the first end plate on the first axial side of the laminated core,
arranging the second end plate on the second axial side of the laminated core,
winding the rotor windings respectively around an end plate projection of the first end plate, an axially opposite end plate projection of the second end plate and a laminated core projection of the laminated core extending axially between the two end plate projections,
arranging pole separators respectively between two adjacent laminated core projections of the laminated core,
axially covering the first end plate with the first end cap,
axially covering the second end plate with the second end cap,
arranging the cooling channel between two adjacent rotor windings such that the cooling channel runs axially from the first end cap to the second end cap, and
potting the rotor windings with a potting compound such that the cooling channel is embedded in the potting compound.

13. The method as claimed in claim 12, wherein, for potting, the rotor is positioned such that its axis of rotation runs vertically, and the potting compound is introduced through a filling opening in an end cap, the end cap preferably also having a venting opening.

14. The rotor as claimed in claim 2, wherein the cooling channel is pressed into the end caps.

15. The rotor as claimed in claim 3, wherein the first axial end of the cooling channel has an inlet for coolant and the second axial end of the cooling channel has an outlet for coolant.

16. The rotor as claimed in claim 2, wherein the cooling channel is embedded in a potting compound.

17. The rotor as claimed in claim 2, with a plurality of pole separators, which are each arranged between two adjacent laminated core projections of the laminated core.

18. The rotor as claimed in claim 2, wherein the cooling channel is produced from a steel alloy, an aluminum alloy or a plastics material.

19. The rotor as claimed in claim 2, with a plurality of cooling channels corresponding to the cooling channel, the number of which corresponds to the number of poles of the rotor or deviates from the number of poles.

20. An electric machine, with a rotor as claimed in claim 2 and a stator surrounding the rotor.
